(19) United States
(12) Patent Application Publication
(10) Pub. No.: US 2007/0104335 A1
(43) Pub. Date: May 10, 2007

(54) Acoustic feedback suppression for audio amplification systems

(75) Inventors: Yong Shi, Shenzhen (CN); Jing Sun, Shenzhen (CN)

Correspondence Address: BUCHANAN, INGERSOLL & ROONEY PC, POST OFFICE BOX 1404, ALEXANDRIA, VA, 22313-1404, US

(73) Assignee: GPE International Limited, Hong Kong (CN)

(21) Appl. No.: 11/389,138

(22) Filed: Mar. 27, 2006

(30) Foreign Application Priority Data
Nov. 9, 2005 (CN) 05109977.3

(51) Int. Cl. H04B 15/00; H04R 27/00

(52) U.S. Cl. 381/93; 381/83; 381/66

(57) ABSTRACT

In a method of acoustic feedback suppression, digitized time-domain samples of acoustic signals are obtained, and discrete time-frequency transformation is performed on the digitized time-domain samples to generate a plurality of frequency bins of a frequency resolution. A howling frequency bin is identified, where the howling frequency has the maximum magnitude among the plurality of frequency bins. A peak frequency within the howling frequency bin is detected, and this peak frequency is suppressed.

### FIELD OF THE INVENTION

This invention relates to acoustical feedback suppression and, more particularly, to acoustical feedback suppression for audio amplification systems. More specifically, this invention relates to acoustical feedback suppression for audio amplification systems with real-time audio input and output such as a PA system.

### BACKGROUND OF THE INVENTION

In an electronic audio amplification system with audio output which can be picked up by the system input, the picking up of an acoustical resonant frequency by the system input can result in undesirable behaviours such as distortion or system instability. The undesirable behaviours are typically recognizable as howling or whistling which can be unpleasant and sometimes intolerable. Hence, it is desirable that adverse acoustical feedback is suppressed to alleviate, if not eliminate, such undesirable behavior. An example of such audio amplification system is a public address system, a Karaoke system or a concert amplification system as shown in FIG. 1. Such amplification systems typically comprise an audio pick-up means such as a microphone or microphones, sound delivery means such as loudspeakers, and audio power amplifiers for amplifying audio signals picked up by the microphones. Hearing aids are another example of such an amplification system.

However, it is known that an adverse acoustic resonant frequency of an audio amplification system is dependent on multiple factors such as the relative positioning of microphones and loudspeakers as well as the acoustic properties of a venue, for example, the sound absorption characteristics of a venue and the presence of objects in the acoustic paths. In a nutshell, an adverse acoustic resonant frequency of an audio amplification system is a dynamic variable which is dependent on the instantaneous acoustical characteristics of the venue of application, the suppression of adverse acoustical feedback frequencies is hitherto best done by adaptive or dynamic resonant feedback suppression means which includes the application of adaptive filtering.

For example, U.S. Pat. No. 5,245,665 describes a method of dynamic acoustical feedback suppression in which audio signals are digitized, sampled and then converted into the frequency domain by Fast Fourier Transform (FFT). The frequency spectrum of the sampled audio signals is then analyzed to identify the presence of any resonating frequencies to be suppressed. Specifically, the frequency component with the maximum magnitude in the frequency spectrum is identified. The magnitude value of the peak magnitude frequency is compared with the magnitude of a selected harmonic of that frequency. If the magnitude of that maximum magnitude frequency exceeds that of the selected harmonic by a predetermined factor, that maximum magnitude frequency will be categorized as an adverse resonant frequency and will be suppressed, for example, by a digital notch filter. Digital notch filers and their applications for acoustic feedback suppression are described in U.S. Pat. No. 5,245,665, U.S. Pat. No. 5,999,631, U.S. Pat. No. 6,611,600. These documents are incorporated herein by reference.

To identify the feedback resonant frequency for howling suppression, an acoustical feedback suppression means for an audio amplification system typically comprises a frequency analyzing means for identifying the specific feedback resonant frequency. The frequency analyzing means usually comprises FFT or other time-frequency transformation means for converting time-domain signals into a frequency domain spectrum. The frequency domain spectrum thus obtained is then analyzed to identify the howling component frequency. In a conventional howling suppression means, the howling frequency is usually located by seeking the frequency with the maximum signal level or magnitude.

However, due to practical and economical allocation of signal processing resources within the amplification system while meeting the requirements of a timely response, the time-frequency transformation means typically divide the entire usable audio frequency into a plurality of bands or frequency bins, which represent the best frequency resolution that can be achieved for a given system. For example, for a FFT with a frame size N and a sampling rate of S Hz, the frequency resolution per frequency bin is S/N Hz. Hence, for a FFT with a 1024 frame size at the sampling rate of 44.1 kHz, the frequency resolution is at 43.066 Hz. The suppression of this entire frequency bin results in deterioration of sound quality and is therefore not desirable.

### OBJECT OF THE INVENTION

Accordingly, it is an object of this invention to provide means, methods, schemes and/or apparatus for enhanced acoustical feedback suppression for an audio amplification system. More specifically, although not solely limited thereto, it is an object of this invention to provide means and method for acoustical feedback suppression in which an adverse feedback resonant frequency is isolated from a frequency band for subsequent suppression. At a minimum, it is an object of this invention to provide the public with a useful choice of a novel acoustic feedback suppression means and method for application in audio amplification systems.

In the description below, the terms “howling frequency” and “feedback resonant frequency” will be used interchangeably to describe the adverse resonant feedback frequency which causes howling and/or other undesirable feedback behaviours in the type of acoustic system described above.

### SUMMARY OF THE INVENTION

Broadly speaking, the present invention has described a method of acoustic feedback suppression, comprising the steps of:
i). obtaining digitized time-domain samples of acoustic signals,
ii). performing discrete time-frequency transformation on the digitized time-domain samples to generate a plurality of frequency bins of a frequency resolution,
iii). identifying a howling frequency bin, said howling frequency bin containing a maximum magnitude among the plurality of frequency bins,
iv). isolating a peak frequency within said howling frequency bin for suppression, and
v). suppressing said peak frequency.
   The isolation of a peak frequency from a frequency bin makes possible the suppression of the howling frequency from a frequency bin so that the non-howling frequencies within the bin are not unnecessarily suppressed.

According to a preferred embodiment of the present invention, the frequency bin is of a pre-determined frequency resolution, the method further comprises the step of increasing the frequency resolution of the howling frequency bin prior to frequency peak detection.

Preferably, said the frequency resolution of the howling frequency bin is increased by zero-padded windowing.

Preferably, the time-domain acoustic samples are obtained at a sampling frequency and the frequency resolution of a frequency bin is dependent on the ratio between the sampling frequency.

Preferably, the discrete time-frequency transformation is FFT.

Preferably, a frequency bin is identified as a howling frequency bin containing a howling frequency if the magnitude of that frequency bin exceeds a pre-determined threshold magnitude threshold for a pre-determined plurality of times.

Preferably, said magnitude being the power magnitude of the frequency bins.

Preferably, a frequency peak within the howling frequency bin is detected by subjecting the time-domain acoustic samples to a windowing operation, the windowing operation is performed with a windowing function which operates to convert a frequency spike windowing function which operates to convert a frequency spike into a frequency spectrum with a spread peak.

Preferably, spread peak has a parabolic shape.

Preferably, the windowing function is Gaussian distributed.

Preferably, Gaussian windowing function is zero padded, the time-domain samples of said acoustic signals are multiplied by the Gaussian windowing function whereby the frequency spectrum after the time-frequency transformation is broadened.

Preferably, the windowing function size is a number between 2 and 1024.

Preferably, the windowing function size is a number between 30 and 200.

Preferably, the windowing function size is 128.

Preferably, the windowing function has a parabolic-shaped peak.

Preferably, the windowing function is a Blackman window, a Hamming window, a Hamming window or a Gaussian window.

Preferably, the windowing function is zero padded, the time-domain samples of said acoustic signals are multiplied by the windowing function whereby the frequency spectrum after the time-frequency transformation is broadened.

Preferably, the discrete time-frequency transformation of said digitized timed-domain samples of said acoustic signals is by Fast Fourier Transform (FFT) with a pre-determined frame size, the number of said frequency bins being half of the frame size plus one, the frequency resolution of each said frequency bin being equal to the sampling frequency divided by the frame size.

Preferably, the howling frequency is located by matching a second order parabolic function to the howling frequency bin and the immediately adjacent frequency bins, the peak of said parabolic curve being said howling frequency.

Preferably, the second order parabolic function has the following form:
howling frequency=−0.5*(bn*ad)/(bd*an), where
an=(A1-A2)*(f1-f3)−(A1-A3)*(f1-f2)
ad=(f1ˆ2-f2ˆ2)*(f1-f3)−(f1ˆ2-f3ˆ2)*(f1-f2)
bn=(A1-A2)*(f1ˆ2-f3ˆ2)−(A1-A3)*(f1ˆ2-f2ˆ2)
bd=(f1-f2)*(f1ˆ2-f3ˆ2)−(f1-f3)*(f1ˆ2-f2ˆ2)
wherein, f2 is the frequency of frequency bin Pi with the maximum magnitude□f1 is the frequency of frequency Pi−1, f3 is the frequency of frequency Pi+1 A2 is the power magnitude of Pi, A1 is the power magnitude of (Pi−1), A3 is the power magnitude of (Pi+1).

### BRIEF DESCRIPTION OF THE DRAWINGS

Preferred embodiments of the present invention will be explained in further detail below by way of examples and with reference to the accompanying drawings, in which:

FIG. 1 shows a typical setup of an audio amplification system for conventional concert or public address (PA) applications,

FIG. 2 is a system block diagram illustrating a preferred embodiment of a means for acoustic feedback suppression using this invention,

FIG. 3 is a flow chart illustrating an exemplary embodiment of this invention,

FIG. 4 is a parabolic graph showing the identification of a howling frequency using this invention,

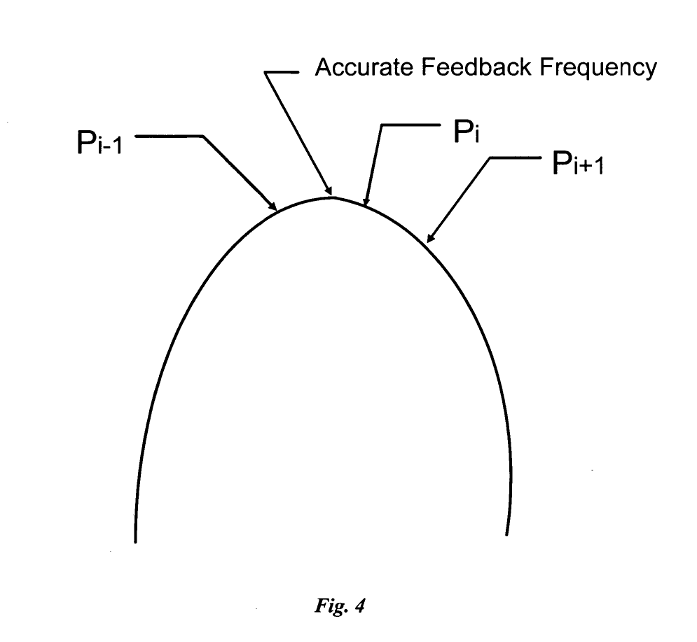

FIG. 5 shows an exemplary connection between the incoming data path and the outgoing data path,

FIG. 6 shows an alternative output configuration of the due buffer of FIG. 5,

FIG. 7 shows an exemplary Gaussian windowing function for application in the present preferred embodiment,

FIG. 8 shows an exemplary distribution in the frequency domain when a 1 kHz sinusoidal frequency undergoes the windowing operation of FIG. 7 under a frame size 1024 and sampling rate of 44.1 kHz environment,

FIG. 9 illustrates in more detail the location of the peak frequency by parabolic interpolation.

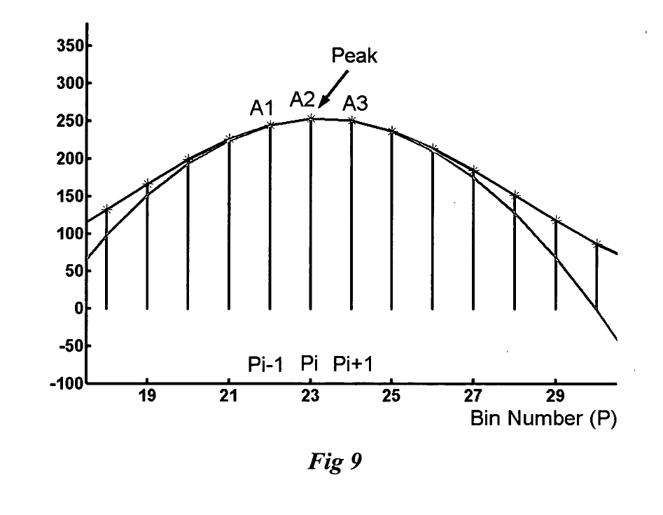

### DETAILED DESCRIPTION OF THE PREFERRED EMBODIMENTS

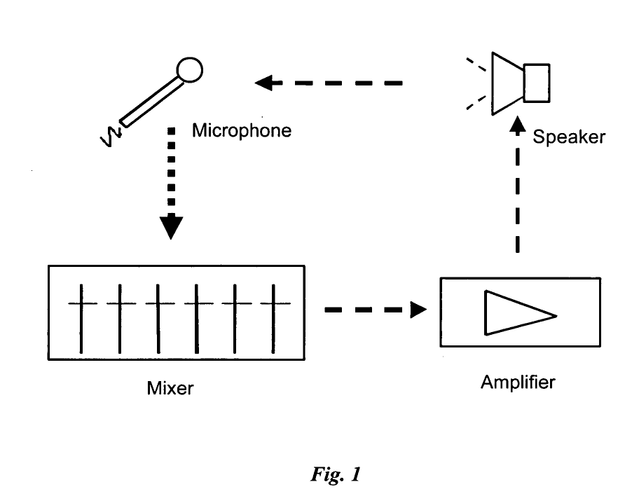

FIG. 1 shows a typical set-up of an audio amplification system in which the invention of this application finds exemplary applications. The exemplary audio amplification system comprises a microphone as an audio pick-up means, an optional mixer for mixing a variety of audio inputs from a plurality of sources, an audio power amplifier for amplifying the audio signals and a loudspeaker for delivering the amplified audio signals to the audience. During operating of the audio amplification system, audio signals containing an adverse feedback resonant frequency may be delivered by the loudspeakers. This adverse feedback resonant frequency when picked up again by the microphone will develop into howling or other unstable phenomenon in the audio amplification system. To suppress howling, it is desirable that the howling frequency is detected and suppressed before or during audio power amplification for optimized sound output.

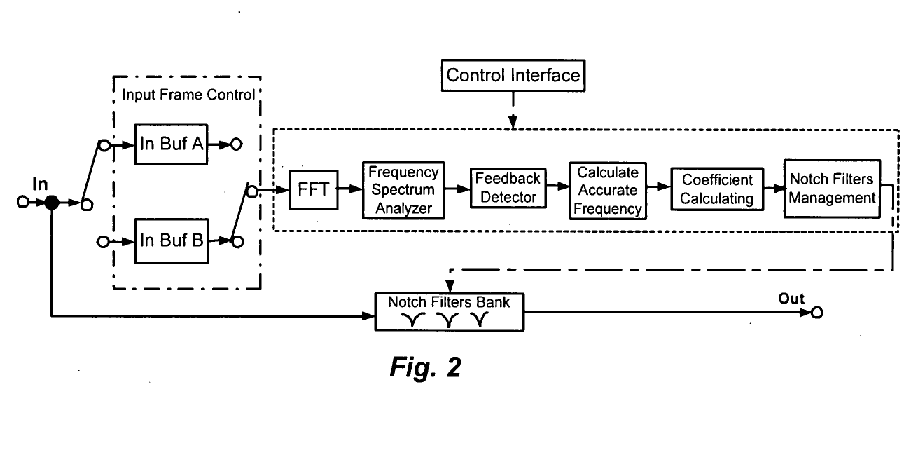

FIG. 2 is a block diagram illustrating an acoustic feedback suppression means comprising a preferred embodiment of this invention. The feedback suppression means can be configured as a front-end to an audio power amplifier, as an integral part of a power amplifier or disposed at any appropriate node between the audio pick-up means (for example, microphones) and the sound delivery means (loudspeakers). The exemplary feedback suppression means comprises a) audio signal sampling means (100), b) signal processing means (200), c) spectral analyzing means (300), d) howling detection means (400), e) howling frequency identification means (500) and f) howling frequency suppression means (600).

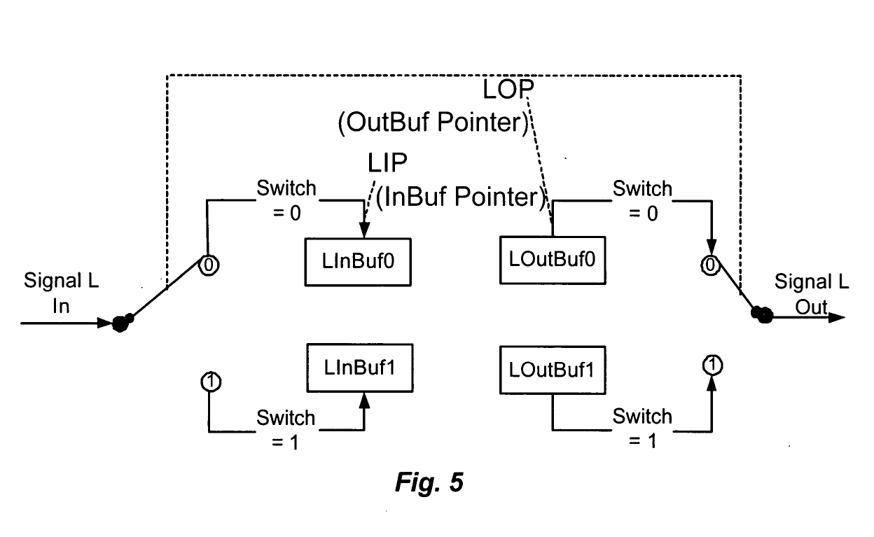

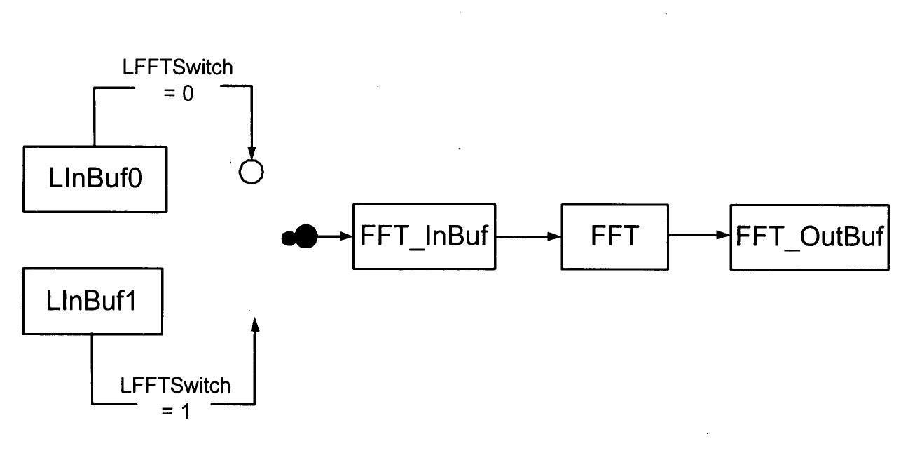

The audio signal sampling means (100) comprises sampling means for taking samples of the audio signals to be amplified, means for digitizing the audio signal samples and data storage means for storing the sampled data for subsequent use. The sampling means operates at an appropriate sampling rate or frequency in order to capture sufficient data points for accurate signal processing. The sampling frequency is usually, but not necessarily, set at the Nyquist sampling frequency or above. For most practical audio systems, an audio bandwidth of 22 kHz is usually considered sufficient. Hence, an exemplary sampling frequency of 44.1 kHz is used in the sampling means. Of course, higher or lower sampling frequencies can be used for appropriate fidelity requirements as known by persons skilled in the art and without loss of generality. The digitizing means then converts an audio sample into a stream of digital data, such as PCM data, for subsequent processing. The data storage means comprises first (110) and second (110) data frame buffer. Each of the two data buffers, namely, InBufA and InBufB, has a storage capacity for storing a plurality (N) of digitized signal samples. The storage capacity of the data buffers in this example is set at N=1024 samples, which is identical to the size of the FFT to be described below for reasons to be explained. Of course, it should be appreciated that the storage capacity of the buffers can be a number other than N=1,024 to commensurate with system configuration. A dual data buffer topology as shown in FIGS. 2, 5 and 6 is employed in this preferred embodiment to enhance processing speed. With a dual or multiple buffer topology, sampled data already stored in one data buffer can be processed by the signal processing means while another batch incoming of data are being load and stored into another data buffer. Of course, a single buffer topology can be used.

Howling in an audio system is due to one or more resonant feedback frequencies. In frequency domain, each of the feedback resonant frequencies will appear as an isolated frequency spike with the peak of each frequency spike standing out well above the frequency spectrum of the adjacent non-howling and desirable audio signals. Typically, the peak of the frequency spike is at least 20-30 dB above the floor of desirable signal in the frequency spectrum. To eliminate or mitigate howling, each of the resonant frequency spike is detected and subsequently suppressed, or, even better, eliminated. As a frequency bin represents the minimum frequency resolution of a digital audio system utilising FFT or other derived time-frequency transformation means, such as STFT (Short-Time Fourier Transform), the specific spike frequency is identified within a frequency bin to alleviate the need to suppress the entire frequency bin, even though a single frequency spike is responsible for howling. In order to identify the spike frequency within a frequency bin, spectrum analysis is performed by windowing operation on the sampled time-domain sampled signal data. Specifically, the time-domain sampled signal data of length N is multiplied by a spectrum analysis window of a length M, where M<N and N is the FFT size which is typically a power of 2 larger than M.

This windowing operation serves two main purposes. Firstly, it increases the number of bins per Hz, whereby increasing the accuracy of the subsequent frequency peak detection. Secondly, it transforms a frequency spike into something easier to analyse. Specifically, it transforms a frequency spike into an expanded frequency curve to facilitate easier and more accurate peak detection.

For the first purpose, the spectrum analysis window is zero-padded so that the window function X(n) has a zero value for:
M≦n<N

The zero-padding factor N/M is also called an interpolating factor for the spectrum. That is, each FFT bin is replaced by N/M bins, interpolating the spectrum.

To achieve the second purpose, a spectrum analysis window which operates to broaden a frequency spike into a frequency curve is used. Gaussian, Hamming, Hanning, Blackman, Nuttallwin, Bartlett and Bohmanwin are examples of suitable spike broadening window functions. An exemplary application of the above with will described with reference to the specific example below.

In order to identify the howling frequency, the time-domain sampled signal data are first transformed into the frequency domain. Windowing operation is performed on the sampled signal data, for example, by dot multiplication of a frame of sample data by zero-padded Gaussian data, whereby the frequency spike is widened into a curve. In choosing an appropriate windowing function, a windowing function which can operate on a frequency spike to convert the frequency spike into a spectrum with a parabolic-shaped peak and distribution is selected. The Blackman Window, the Hamming Window and the Gaussian Window are examples of common windowing functions which have such a parabolic-shaped peak and conversion characteristics.

In this example, Gaussian windowing is used to perform sample data multiplication on the sampled signal data. Of course, it will be appreciated that the Fourier Transform of a Gaussian function is itself a Gaussian function and the frequency passing characteristics follow the well-known Gaussian curve. To implement Gaussian windowing operation, the signal processing means (200) comprises a Gaussian window operator and a discrete time-frequency transformation means such as an FFT operator. By performing a windowing operation on the stored sample data by a Gaussian window, a howling frequency can be located from a frequency bin to be explained below. The processing of the sampled signal data to identify a howling frequency will also be described below.

After a data buffer is full, Gaussian windowing operation is performed on the stored time domain signal data samples. The N windowed data points resulting from the Gaussian operation are stored in the memory for processing by discrete time-frequency transformation means. The FFT operator then transforms the N windowed data into the frequency domain.

The discrete time-frequency transformation means in this example is an FFT operator with a size of N points. FFT operation on the N Gaussian windowed samples will result in N/2+1 frequency bins. An FFT of a size N identical to the size of the data buffer is selected so that there will be an identical number of resulting data frames. The complex frequency data, comprising real and imaginary parts, are stored into a memory buffer for use. An FFT with a size of N=1,024 is used in this example. Of course, the FFT size N could be any convenient 2^{x} numbers such as 512, 1,024, 2,048, 4,096 etc. For an FFT size of N and a sampling frequency of S, there will be N/2+1 frequency bins and the frequency resolution will be S/N, which is 43.066 Hz for the instant example with N=1,024 and S=44.1 kHz.

The spectral analyzing means (300) comprises means for evaluating the magnitude of the frequency bins. For example, the power or voltage spectrum of the frequency bins can be calculated from the complex frequency components as is known to persons skilled in the art.

The howling detection means (400) comprises means for identifying howling. Specifically, the howling detection means (400) comprises means for identifying a frequency bin with the maximum magnitude, means for comparing the maximum magnitude with a predetermined threshold which represents or is indicative of a howling level, and means for confirming the identification of a howling frequency. The maximum magnitude can be a power or voltage magnitude which is indicative of howling. Of course, the howling level will be adjustable depending on the application, environment or other factors known to persons skilled in the art. The howling detection means will recognise a frequency bin as one which contains a howling frequency if the magnitude of that frequency bin has been the maximum among the plurality of frequency bins for a consecutive number of times and the magnitude exceeds the maximum threshold which is pre-determined by the system, for example, by user adjustment.

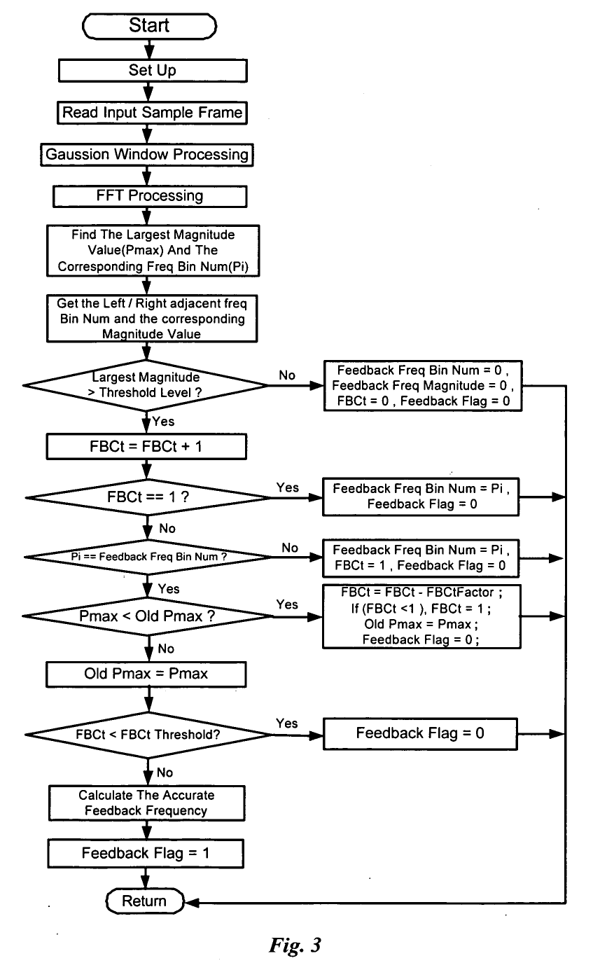

After a frequency bin containing a howling frequency has been identified, the howling frequency identification means (500) operates to locate the specific howling frequency from the entire frequency bin. In this example, parabolic interpolation is used to locate the howling frequency within the frequency bin containing the peak magnitude which is indicative of howling. Parabolic interpolation is used because this provides a convenient way to identify a peak frequency from a parabolic shaped peak as shown in FIG. 3.

The phenomenon of howling in an audio system is typically recognized by a characteristic squeak sound. This squeak sound when translated into the frequency spectrum is typically a single frequency spike which distinctively stands out from the spectrum floor in its immediate and proximal vicinity to give it such a remarkable presence. When this frequency spike undergoes Gaussian windowing and then FFT operations the resulting frequency spectrum of the howling frequency has a Gaussian distribution with the peak portion having a parabolic shape. This parabolic shaped Gaussian peak is dominant in the frequency bin containing it and the neighbouring frequency bins since, by its very nature, the magnitude of the howling frequency peak must be the dominant component. The peak frequency, which is the howling frequency, can be isolated identified by parabolic interpolation in an exemplary manner as described below.

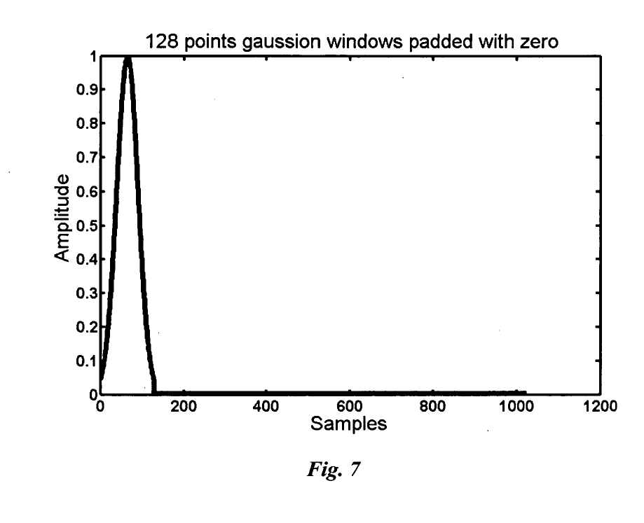

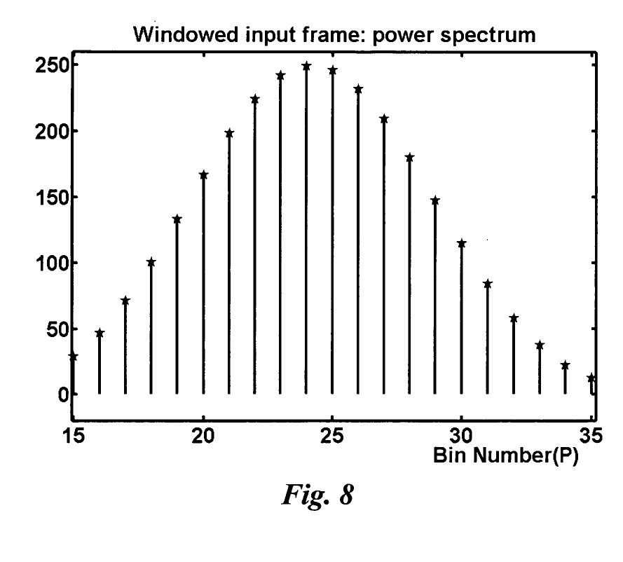

Referring to FIGS. 7 and 8, an exemplary application of parabolic interpolation to identify a howling frequency is described. With reference to a system with a sampling rate of 44.1 kHz and a sampling size of 1024 with a sinusoidal frequency spike at 1 kHz. Due to the resolution of each frequency bin, the 1 kHz spike frequency will be located in bin number 23, since 1000/(44,100/1024)=23.22. A Gaussian window of 128 points with the remaining points padded with zero is used in this example. In particular, any number between 2 and 1024 can be used for a system with a sampling size of 1024. Empirally, a number between 30 and 200 is found to produce a good result.

In order to locate the peak frequency with a finer resolution and better certainty, a second order parabolic function G(f) is used to fit onto the peak portion of the frequency spectrum, where, G(f)=af²+bf+c, where f is frequency in Hz. The coefficients of the parabolic function G(f) are obtained by the magnitudes A₁, A₂ and A₃ at the frequencies f₁, f₂ and f₃, wherein f₁, f₂ and f₃ are the characteristic frequency of each frequency bin.

Thus, the second order function G(f)=af²+bf¹ +c can be solved by the following equations:

$$\{ \begin{matrix}G ( {f}_{1} ) = {af}_{1}^{2} + {bf}_{1} + c \\ G ( {f}_{2} ) = {af}_{2}^{2} + {bf}_{2} + c \\ G ( {f}_{3} ) = {af}_{3}^{2} + {bf}_{3} + c\end{matrix}$$

and the respective coefficients a, b, c are:

$$\{ \begin{matrix}a = \frac{( G ( {f}_{1} ) - G ( {f}_{2} ) ) ( {f}_{1} - {f}_{2} ) - ( G ( {f}_{1} ) - G ( {f}_{3} ) ) ( {f}_{1} - {f}_{2} )}{( {f}_{1}^{2} - {f}_{2}^{2} ) ( {f}_{1} - {f}_{3} ) - ( {f}_{1}^{2} - {f}_{3}^{2} ) ( {f}_{1} - {f}_{2} )} \\ b = \frac{( G ( {f}_{1} ) - G ( {f}_{2} ) ) ( {f}_{1}^{2} - {f}_{3}^{2} ) - ( G ( {f}_{1} ) - G ( {f}_{3} ) ) ( {f}_{1}^{2} - {f}_{2}^{2} )}{( {f}_{1}^{2} - {f}_{3}^{2} ) ( {f}_{1} - {f}_{2} ) - ( {f}_{1}^{2} - {f}_{2}^{2} ) ( {f}_{1} - {f}_{3} )} \\ c = G ( {f}_{1} ) - a * {f}_{1}^{2} - b * {f}_{1}\end{matrix}$$

The frequency peak at

$$\frac{\partial G ( f )}{\partial f} = 0$$

and the frequency (f) is

$$f = - \frac{b}{2 a} .$$

Consequently

$$f = - 0.5 * \frac{bn * ad}{bd * an}$$

where

$$a = \frac{an}{ad} , b = \frac{bn}{bd}$$

$$\{ \begin{matrix}an = ( G ( {f}_{1} ) - G ( {f}_{2} ) ) ( {f}_{1} - {f}_{3} ) - ( G ( {f}_{1} ) - G ( {f}_{3} ) ) ( {f}_{1} - {f}_{2} ) \\ ad = ( {f}_{1}^{2} - {f}_{2}^{2} ) ( {f}_{1} - {f}_{3} ) - ( {f}_{1}^{2} - {f}_{3}^{2} ) ( {f}_{1} - {f}_{2} ) \\ bn = ( G ( {f}_{1} ) - G ( {f}_{2} ) ) ( {f}_{1}^{2} - {f}_{3}^{2} ) - ( G ( {f}_{1} ) - G ( {f}_{3} ) ) ( {f}_{1}^{2} - {f}_{2}^{2} ) \\ bd = ( {f}_{1}^{2} - {f}_{3}^{2} ) ( {f}_{1} - {f}_{2} ) - ( {f}_{1}^{2} - {f}_{2}^{2} ) ( {f}_{1} - {f}_{3} )\end{matrix}$$

General peak detection techniques are described in “An Analysis/Synthesis Program for Non-Harmonic Sounds Based on a Sinusoidal Representation”, by Julius O. Smith III and Xavier Serra, Proceedings of the International Computer Music Conference (ICMC-87,Tokyo), Computer Music Association, 1987” which is incorporated herein by reference.

After the howling frequency has been located, the howling frequency suppression means (600) will operate to suppress the howling frequency. The howling frequency suppression means can contain notch filters to suppress the howling frequency. To facilitate overall howling suppression, the howling frequency suppression means may contain a fixed notch filter and a dynamic filter. The fixed notch filter can be determined by the amplification system at power up by calibrating the venue or room characteristics. The dynamic filter is for suppressing instantaneous howling feedback which may be generated due to moving objects, such as microphones. An exemplary notch filter with a notch depth μ is set out below as a convenient example.

$$b 0 = \frac{1.0}{1 + tan ( 0.5 * 2 π * fc * Q / 1024 )}$$

where fc=howling frequency
b1=−2.0*cos(2π*Pi[i]*Q[i]/1024)*b0
b2=b0
a1=−2.0*b0*cos(2π*Pi[i]/1024)
a2=2.0*b0−1.0
b0=b0*μ+(1−μ)
b1=b1*μ+a1*(1−μ)
b2=b2*μ+a2*(1−μ)

An exemplary operation of the feedback suppression means of this invention will be explained with reference to the flow diagram of FIG. 3. Referring to FIG. 3, when the feedback suppression means is initiated, samples of the audio signals in the surrounding environment are taken. The audio samples are then digitized and stored in memory. The digitized sampled data are then operated by Gaussian windowing. The Gaussian window operated sampled data are then fed into the FFT means. The FFT means then converts the Gaussian windowed sample audio data into frequency domain components comprising real and imaginary parts. The FFT operation will generate the N/2+1 frequency bins and the real and imaginary parts of the N/2+1 frequency bins will be stored in memory. Next, the frequency data of the frequency bins are operated to identify the frequency bin with the maximum magnitude. After the frequency bin with the maximum magnitude has been identified, the maximum magnitude will be compared to a pre-determined threshold magnitude which represents howling. If the maximum magnitude occurs at the same frequency bin for a consecutive number of times and the maximum magnitude exceeds the pre-determined threshold magnitude for each of the consecutive repetition, the frequency bin containing that maximum magnitude will be processed so that a howling frequency will be isolated for suppression.

On the other hand, if the maximum magnitude does not occur at the same frequency bin for a pre-determined number of consecutive number of time, the system counter will be reset and the howling frequency seeking exercise will be repeated. Likewise, even when the maximum frequency occurs at the same frequency bin for a pre-determined number of times but the maximum magnitude does not exceed the threshold value for each of the consecutive number of times, the system counter will be reset on the basis that there is no annoying howling.

Once a frequency bin containing a howling frequency is identified, the system will operate to isolate the specific howling frequency by matching a second order parabolic function as mentioned above with the magnitude of the frequency bin (Pi) and the immediately adjacent frequency bins (Pi−1 and Pi+1). After the specific howling frequency has been identified by matching the second order parabolic function with the frequency bins, the specific howling frequency will be suppressed by a very narrow notch filter as understood by persons skilled in the art. Compared to conventional howling suppression means in which the entire frequency bin containing the howling frequency is suppressed, this invention represents a significant improvement since only a portion of the frequency bin will be suppressed. As a result, audio signal distortion is reduced and fidelity is enhanced.

While the present invention has been explained with reference to the examples or preferred embodiments described above, it will be appreciated that those are examples to assist understanding of the present invention and are not meant to be restrictive. The scope of invention should be determined from the claims with reference to the Figures and the description as understood by persons skilled in the art. Variations or modifications which are obvious or trivial to persons skilled in the art, as well as improvements made thereon, should be considered as falling within the scope and boundary of the present invention.

Furthermore, while the present invention has been explained by reference to the use of Gaussian windowing, it should be appreciated that the invention can apply, whether with or without modification, to other windowing processing means without loss of generality.

1. Amended) A method of acoustic feedback suppression, comprising the steps of:
obtaining digitized time-domain samples of acoustic signals,
performing discrete time-frequency transformation on the digitized time-domain samples to generate a plurality of frequency bins of a frequency resolution,
identifying a howling frequency bin, said howling frequency bin containing a maximum magnitude among the plurality of frequency bins,
isolating a peak frequency within said howling frequency bin for suppression, and
suppressing said peak frequency.

2. A method according to claim 1, wherein each frequency bin is of a pre-determined frequency resolution, the method further comprises the step of:
increasing the frequency resolution of the howling frequency bin prior to frequency peak detection.

3. A method according to claim 1, wherein the frequency resolution of the howling frequency bin is increased by frequency interpolation prior to howling frequency detection.

4. A method according to claim 1, wherein the frequency resolution of the howling frequency bin is increased by zero-padded windowing.

5. A method according to claim 3, wherein the time-domain acoustic samples are obtained at a sampling frequency and the frequency resolution of a frequency bin is dependent on the ratio between the sampling frequency and the size of the discrete time-frequency transformation.

6. A method according to claim 5, wherein the discrete. time-frequency transformation is FFT.

7. A method according to claim 1, wherein a frequency bin is identified as a howling frequency bin containing a howling frequency if the magnitude of that frequency bin exceeds a pre-determined threshold magnitude threshold for a pre-determined plurality of times.

8. A method according to claim 7, wherein said magnitude being the power magnitude of the frequency bins.

9. A method according to claim 1, wherein a frequency peak within the howling frequency bin is detected by subjecting the time-domain acoustic samples to a windowing operation, the windowing operation is performed with a windowing function which operates to convert a frequency spike into a frequency spectrum with a spread peak.

10. A method according to claim 9, wherein said spread peak has parabolic shape.

11. A method according to claim 10, wherein the windowing function is Gaussian distributed.

12. A method according to claim 11, wherein the Gaussian windowing function is zero padded, the time-domain samples of said acoustic signals are multiplied by the Gaussian windowing function whereby the frequency spectrum after the time-frequency transformation is broadened.

13. A method according to claim 10, wherein the windowing function size is a number between 2 and 1024.

14. A method according to claim 10, wherein the windowing function size is a number between 30 and 200.

15. A method according to claim 10, wherein the windowing function size is 128.

16. A method according to claim 9, wherein the windowing function has a parabolic-shaped peak.

17. A method according to claim 9, wherein the windowing function is a Blackman window, a Hamming window, a Hamming window or a Gaussian window.

18. A method according to claim 9, wherein the windowing function is zero padded, the time-domain samples of said acoustic signals are multiplied by the windowing function whereby the frequency spectrum after the time-frequency transformation is broadened.

19. A method of acoustic feedback suppression according claim 1, wherein the discrete time-frequency transformation of said digitized time-domain samples of said acoustic signals is by Fast Fourier Transform (FFT) with a pre-determined frame size, the number of said frequency bins being half of the frame size plus one, the frequency resolution of each said frequency bin being equal to the sampling frequency divided by the frame size.

20. A method of acoustic feedback suppression according to claim 19, wherein the howling frequency is located by matching a second order parabolic function to the howling frequency bin and the immediately adjacent frequency bins, the peak of said parabolic curve being said howling frequency.

21. A method of acoustic feedback suppression according to claim 20, wherein the second order parabolic function has the following form:
howling frequency=−0.5*(bn*ad)/(bn*an), where
an=(A1-A2)*(f1-f3)−(A1-A3)*(f1-f2)
ad=(f1ˆ2-f2ˆ2)*(f1-f3)−(f1ˆ2-f3ˆ2)*(f1-f2)
bn=(A1-A2)*(f1ˆ2-f3ˆ2)−(A1-A3)*(f1ˆ2-f2ˆ2)
bd=(f1-f2)*(f1ˆ2-f3ˆ2)−(f1-f3)*(f1ˆ2-f2ˆ2)
wherein, f2 is the frequency of frequency bin Pi with the maximum magnitude, f1 is the frequency of frequency Pi−1, f3 is the frequency of frequency Pi+1
A2 is the power magnitude of Pi, A1 is the power magnitude of (Pi−1), A3 is the power magnitude of (Pi+1).

22. A method of acoustic feedback suppression according to claim 9, wherein if the maximum power magnitude does not exceed said pre-determined power magnitude threshold for a pre-determined number of times, no howling frequency suppression will be performed.

23. A method of acoustic feedback suppression according to claim 1, wherein suppression of the howling frequency is by a notch filter.

24. An audio system comprising means for suppressing howling, said means for suppressing howling comprises:
means for obtaining digitized time-domain samples of acoustic signals,
means for performing discrete time-frequency transformation on the digitized time-domain samples of generate a plurality of frequency bins of a frequency resolution,
means for identifying a howling frequency bin, said howling frequency having the maximum magnitude among the plurality of frequency bins,
means for detecting a peak frequency within said howling frequency bin for suppression, and
means for suppressing said peak frequency.

25. An audio amplification system comprising means to facilitate a method of acoustic feedback suppression according to claim 1.
